(19) United States
(12) Patent Application Publication
(10) Pub. No.: US 2006/0098139 A1
(43) Pub. Date: May 11, 2006

(54) Liquid crystal display device

(75) Inventor: Minoru Shibazaki, Nishi-ku, Kobe-shi, Hyogo (JP)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., Eindhoven (NL)

(21) Appl. No.: 10/538,445

(22) PCT Filed: Dec. 1, 2003
(86) PCT No.: PCT/IB03/05633

§ 371 Date: Jun. 10, 2005

(30) Foreign Application Priority Data
Dec. 12, 2002 (JP) 2002-361294

(51) Int. Cl. G02F 1/1335

(52) U.S. Cl. 349/98

(57) ABSTRACT

To propose a liquid crystal display device for suppressing a wavelength dependence and a viewing dependence in a dark state. A polarizer (21a) of a circularly polarizer (21) and a polarizer (22a) of a circularly polarizer (22) are arranged such that an absorption axis (90°) of the polarizer (21a) and an absorption axis (0°) of the polarizer (22a) are at substantially right angle to each other. A retardation plate (21b) of a circularly polarizer (21) and a retardation plate (22b) of a circularly polarizer (22) are arranged such that a slow axis (165°) of the retardation plate (21b) and a slow axis (75°) of the retardation plate (22b) are at substantially right angle to each other. A retardation plate (21c) of a circularly polarizer (21) and a retardation plate (22c) of a circularly polarizer (22) are arranged such that a slow axis (105°) of the retardation plate (21c) and a slow axis (15°) of the retardation plate (22c) are at substantially right angle to each other.

### BACKGROUND OF THE INVENTION

1. Field of the Invention

The present invention relates to a liquid crystal display device, particularly to a liquid crystal display device for suppressing wavelength dependence and a viewing dependence in a dark state.

2. Description of Related Art

In a reflective liquid crystal display device, a circularly polarizer is sometimes used to make a dark state (black display) excellent. In the reflective liquid crystal display device using the circularly polarizer, among incident light, either circularly polarized light of right circularly polarized light and left circularly polarized light is absorbed, and only the other circularly polarized light is passed through the circularly polarizer. The circularly polarized light passed through the circularly polarizer varies the direction of circular polarization when being reflected by a reflective plate. The circularly polarized light with the varied direction cannot be passed through the circularly polarizer and absorbed. As a result, it is possible to make a dark state excellent (Japanese Laid-Open Patent Publication No. H06-11711 (paragraph [0050], FIG. 6)).

In applying the circular polarizer to a transflective liquid crystal display device or transmissive liquid crystal display device, in order to make a dark state excellent, it is required to arrange a pair of circularly polarizers on each outside of a liquid crystal cell so as to sandwich the liquid crystal cell. This is because it is intended in light from the backlight in a transmissive mode that one circularly polarizer absorbs either right circularly polarized light or left circularly polarized light, while the other circularly polarizer absorbs the other circularly polarized light.

Thus, when circularly polarizers are used in a transflective liquid crystal display device or transmissive liquid crystal display device, it is required to arrange a pair of circularly polarizers. However, under the current circumstances, consideration is not given to a wavelength dependence and a viewing dependence in a dark state of the circularly polarizers.

### SUMMARY OF THE INVENTION

In view of the foregoing, it is an object to provide a liquid crystal display device capable of suppressing the wavelength dependence and viewing dependence in a dark state.

A liquid crystal display device of the present invention has a liquid crystal cell having at least transmissive mode, and a pair of circularly polarized light means having optical axes which are at substantially right angle to each other, and sandwiching the liquid crystal cell.

According to this arrangement, since the device is provided with a pair of circularly polarized light means having optical axes which are at substantially right angle to each other, the means mutually cancels variations in optical characteristics such as retardation. Therefore, the viewing dependence is suppressed, the wavelength dependence is canceled thoroughly, and coloring in a dark state is thus eliminated completely.

In the liquid crystal display device of the present invention, it is preferable that the pair of circular polarized light means has a pair of polarizers, and a pair of retardation plates, which have optical axes that are at substantially right angle to each other, arranged inside the pair of polarizers.

In the liquid crystal display device of the present invention, it is preferable that the pair of circular polarized light means has a plurality of pairs of polarizers.

In the liquid crystal display device of the present invention, it is preferable that the pair of retardation plates are uniaxial retardation plate or biaxial retardation plate. In addition, it is preferable that the biaxial retardation plate has Nz values in the range of 0 to 1.

In the liquid crystal display device of the present invention, it is preferable that at least one of the pair of polarizers is a wide viewing angle polarizer.

In the liquid crystal display device of the present invention, it is preferable that an optical axis of the retardation plate is a slow axis.

### BRIEF DESCRIPTION OF THE DRAWINGS

FIG. 1 is a sectional view showing an arrangement of a liquid crystal display device according to Embodiments 1 to 4 of the present invention;

FIG. 2 is a view showing an arrangement of a circularly polarizer according to Embodiment 1 of the present invention;

FIG. 3 is a view showing a viewing dependence in a dark state in a liquid crystal display device according to Embodiment 1 of the present invention;

FIG. 4 is a view showing a wavelength dependence in a dark state in a liquid crystal display device according to Embodiments 1 to 4 of the present invention;

FIG. 5 is a view showing an arrangement of a circularly polarizer of a liquid crystal display device of a comparison example;

FIG. 6 is a view showing a viewing dependence in a dark state in a liquid crystal display device of comparison example;

FIG. 7 is a view showing a wavelength dependence in a dark state in a liquid crystal display device of a comparison example;

FIG. 8 is a view showing an arrangement of a circularly polarizer according to Embodiment 2 of the present invention;

FIG. 9 is a view showing a viewing dependence in a dark state in a liquid crystal display device according to Embodiment 2 of the present invention;

FIG. 10 is a view showing an arrangement of a circularly polarizer according to Embodiment 3 of the present invention;

FIG. 11 is a view showing a viewing dependence in a dark state in a liquid crystal display device according to Embodiment 3 of the present invention;

FIG. 12 is a view showing an arrangement of a circularly polarizer according to Embodiment 4 of the present invention; and

FIG. 13 is a view showing a viewing dependence in a dark state in a liquid crystal display device according to Embodiment 4 of the present invention.

### DESCRIPTION OF THE PREFERRED EMBODIMENT(S)

The subject matter of the present invention is to suppress a wavelength dependence and a viewing dependence in a dark state in a liquid crystal display device by comprising a liquid crystal cell having at least transmissive mode, and a pair of circularly polarized light means having optical axes which are at right angle to each other, and sandwiching the liquid crystal cell.

Embodiments of the present invention will be described specifically below with reference to accompanying drawings.

### Embodiment 1

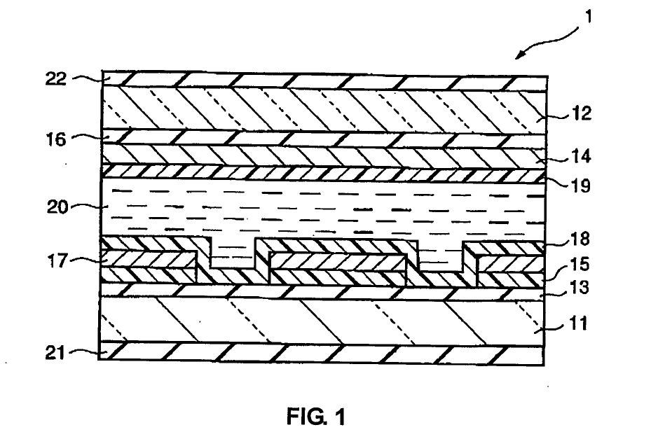

This Embodiment describes a case where a liquid crystal display device is a transflective liquid crystal display device, and a circularly polarizer is comprised of a polarizer and two uniaxial retardation plates. FIG. 1 is a sectional view showing an arrangement of a liquid crystal display device according to Embodiment 1 of the present invention.

In the liquid crystal display device as shown in FIG. 1, a transparent electrode 13 is formed on one main surface of one glass substrate 11. As materials for the transparent electrode 13, for example, there may be ITO (Indium Tin Oxide), zinc oxide based material, titanium oxide based material, indium oxide-zinc oxide based material, Ga-added zinc oxide based material, and p-type oxide material.

A resin layer 15 having transmissive regions patterned in pixels is formed on the transparent electrode 13. As materials for the resin layer 15, general resist materials such as polyimide may be used. Further, a reflective plate 17 is formed on the resin layer 15. As materials for the reflective plate 17, aluminum and silver may be used. Each region provided with the reflective plate 17 is a reflective region, while each region without the reflective plate 17 is a transmissive region.

The patterning of the resin layer 15 and reflective plate 17 can be carried out as described below, for example. The resin layer is formed on the transparent electrode 13, and then, the reflective plate is formed on the resin layer. A resist layer is formed on the reflective plate, patterning is carried out by a photolithography method, and the reflective plate is etched using the patterned resist layer as a mask. Then, the resin layer is etched using the patterned reflective plate as a mask. In this way, the resin layer 15 and reflective plate 17 are formed. In addition, the case is described herein that after the resin layer and reflective plate are laminated, the reflective plate and resin layer are etched and patterned in this order. In the present invention, it may be possible that the reflective plate is laminated and undergoes patterning after the resin layer is laminated and undergoes patterning.

An alignment film 18 is formed on the reflective plate 17 and the transparent electrode 13 in the transmissive region. As materials for the alignment film 18, there may be resin materials such as polyimide.

A color filter 16 is formed on one main surface of the other glass substrate 12. A transparent electrode 14 is formed on the color filter 16, and an alignment film 19 is formed on the transparent electrode 14. As respective materials for transparent electrode 14 and alignment film 19, the same materials as those on the glass substrate 11 may be used.

In addition, transparent electrodes 13 and 14 respectively on glass substrates 11 and 12 compose a matrix of scanning electrode and signal electrode, and enable display. In this way, pixels are formed on a liquid crystal panel 12 as in general liquid crystal panels. Further, as methods of forming transparent electrodes 13 and 14, there may be methods used in manufacturing general liquid crystal display devices such as a sputtering method, for example. As methods of forming alignment films 18 and 19, there may be methods used in manufacturing general liquid crystal display devices such as a method including a coating process, drying process and rubbing process, for example.

A liquid crystal layer 20 is formed between the glass substrates 11 and 12. The liquid crystal layer 20 is formed by arranging the glass substrates 11 and 12 with formed films such that the alignment films 18 and 19 are opposed to each other, and filling a liquid crystal material into between the glass substrates 11 and 12. A circularly polarizer 21 is disposed on the other main surface of the glass substrate 11, and a circularly polarizer 22 is disposed on the other main surface of the glass substrate 12.

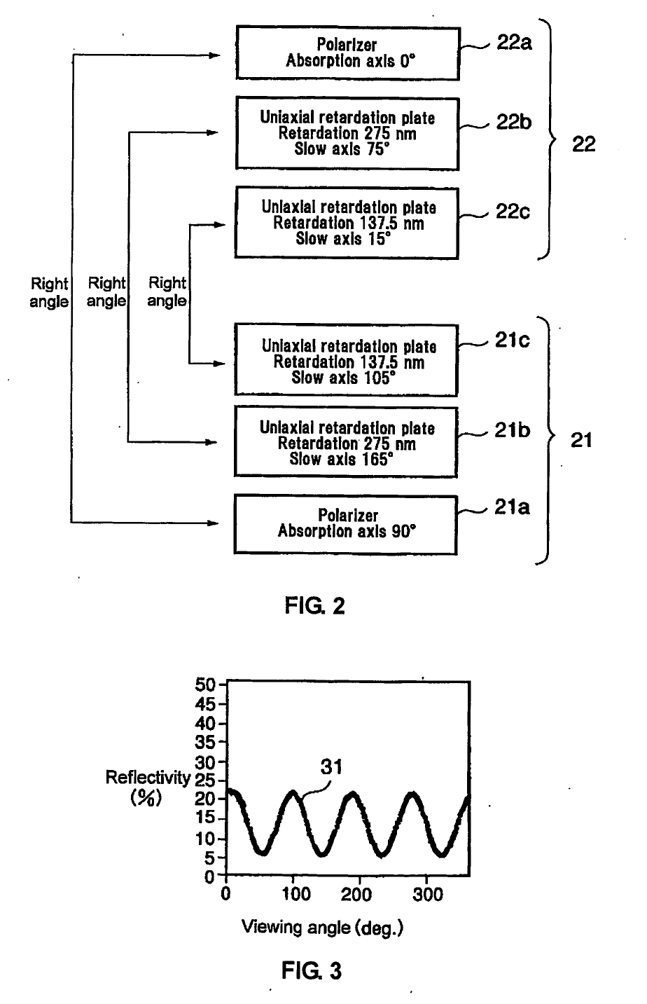

FIG. 2 is a view showing an arrangement of the circularly polarizer of the liquid crystal display device according to Embodiment 1 of the present invention. In addition, in FIG. 2, in order to describe an arrangement of a pair of circularly polarizers, the liquid crystal cell is omitted which actually exists between the pair of circularly polarizers. The circularly polarizer 21 is comprised of a polarizer 21a with an absorption axis of 90°, a uniaxial retardation plate 21b with retardation of 275 nm and a slow axis of 165°, and a uniaxial retardation plate 21c with retardation of 137.5 nm and a slow axis of 105°. The circularly polarizer 21 is obtained by arranging the retardation plate 21c, retardation plate 21b and polarizer 21a on the glass substrate 11 in this order.

When two retardation plates are arranged between the polarizer and liquid crystal cell, it may be possible to paste one retardation plate to the polarizer and paste the other retardation plate to the liquid crystal cell, to paste two retardation plates to the polarizer successively, or to paste two retardation plates to the liquid crystal cell successively.

The circularly polarizer 22 is comprised of a polarizer 22a with an absorption axis of 0° a uniaxial retardation plate 22b with retardation of 275 nm and a slow axis of 75°, and a uniaxial retardation plate 22c with retardation of 137.5 nm and a slow axis of 15°. The circularly polarizer 22 is obtained by arranging the retardation plate 22c, retardation plate 22b and polarizer 22a on the glass substrate 12 in this order. In addition, it is necessary that the circularly polarization direction of the circularly polarizer 22 is inverse to the circularly polarization direction of the circularly polarizer 21.

The polarizer 21a of the circularly polarizer 21 and the polarizer 22a of the circularly polarizer 22 are arranged such that the absorption axis (90°) of the polarizer 21a and the absorption axis (0°) of the polarizer 22a are at substantially right angle to each other. The retardation plate 21b of the circularly polarizer 21 and the retardation plate 22b of the circularly polarizer 22 are arranged such that the slow axis (165°) of the retardation plate 21b and the slow axis (75°) of the retardation plate 22b are at substantially right angle to each other. The retardation plate 21c of the circularly polarizer 21 and the retardation plate 22c of the circularly polarizer 22 are arranged such that the slow axis (105°) of the retardation plate 21c and the slow axis (15°) of the retardation plate 22c are at substantially right angle to each other.

The operation of the liquid crystal display device with the aforementioned arrangement will be described below.

The case of reflective mode will be described first. In the reflective mode, when external light is incident on a liquid crystal display device 1, among the incident light, either circularly polarized light of right circularly polarized light and left circularly polarized light is absorbed, and only the other circularly polarized light is passed through the polarizer 22. The circularly polarized light passed through the circularly polarizer 22 is reflected by the reflective plate 17 of the liquid crystal cell. At this point, the direction of circularly polarization is varied. The circularly polarized light with the varied direction cannot be passed through the circularly polarizer 22 and absorbed in the circularly polarizer 22. As a result, it is possible to make a dark state excellent.

In the transmissive mode, when light from the backlight (not shown) is passed through the circularly polarizer 21, among the light, either right circularly polarized light or left circularly polarized light is absorbed in the circularly polarizer 21. Since the circularly polarization direction of the circularly polarizer 21 and the circularly polarization direction of the circularly polarizer 22 are inverse to each other, with respect to the light passed through the liquid crystal cell subsequently, the other circularly polarized light is absorbed in the circularly polarizer 22. As a result, it is possible to make a dark state excellent.

In the liquid crystal display device, since the device is provided with a pair of circularly polarizers having optical axes which are at substantially right angle to each other, in other words, since slow axes of retardation plates of the pair of circularly polarizers are at substantially right angle to each other, variations in retardation act to cancel each other. Therefore, it is possible to suppress the wavelength dependence and viewing dependence.

Examples will be described herein which were carried out to clarify advantages of the present invention.

The wavelength dependence and viewing dependence regarding the reflectivity were measured in the liquid crystal display device with the arrangement as shown in FIG. 2 provided with a pair of circularly polarizers having optical axes that are at substantially right angle to each other, and in a liquid crystal display device (comparison example) as shown in FIG. 5 provided with a pair of circularly polarizers having optical axes that are substantially parallel to each other. In addition, using a spectral luminance meter, the wavelength dependence was measured in a darkroom with the spectral luminance meter arranged perpendicularly to the panel of the liquid crystal cell, and using a luminance meter, the viewing dependence was measured in a darkroom while rotating a bearing of the panel from 0° to 360° with the luminance meter fixed at 60° to the perpendicular direction of the panel.

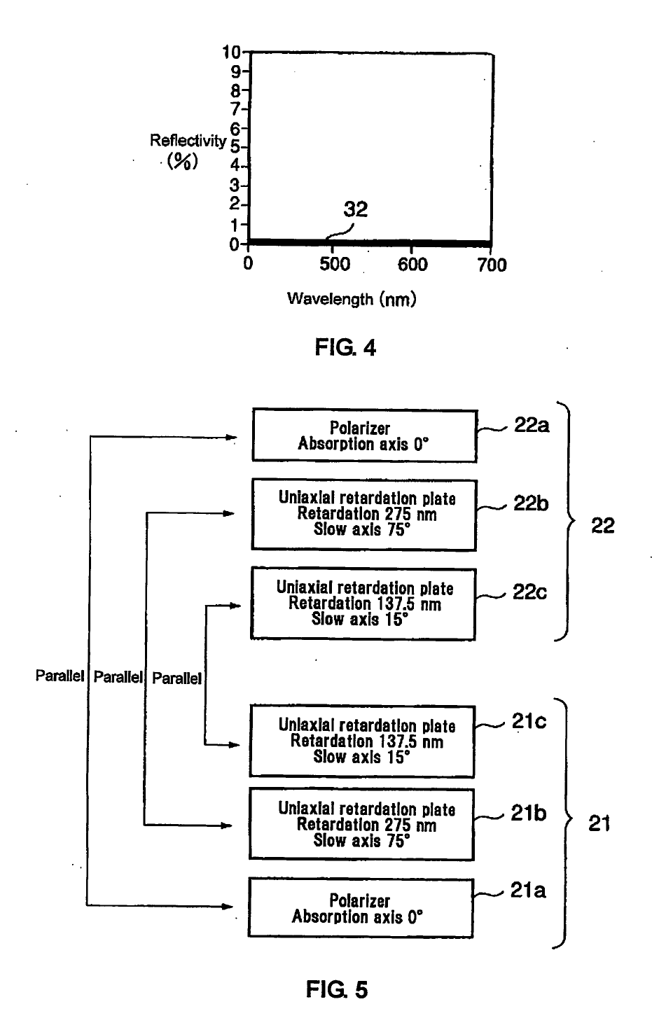

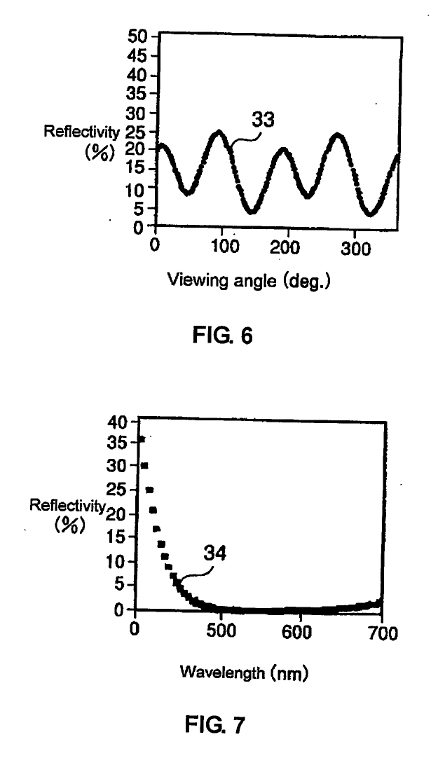

In the liquid crystal display device with the arrangement as shown in FIG. 2 according to this Embodiment, the viewing dependence is as indicted by a characteristic curve 31 as shown in FIG. 3, and the wavelength dependence is as indicted by a characteristic curve 32 as shown in FIG. 4. Further, in the liquid crystal display device of the comparison example, the viewing dependence is as indicted by a characteristic curve 33 as shown in FIG. 6, and the wavelength dependence is as indicted by a characteristic curve 34 as shown in FIG. 7.

In other words, in the arrangement according to this Embodiment, with respect to the wavelength dependence, the slow axis of the retardation plate 21b and the slow axis of the retardation plate 22b are at substantially right angle to each other, and the slow axis of the retardation plate 21c and the slow axis of the retardation plate 22c are at substantially right angle to each other, whereby wavelength characteristics are mutually canceled. The state is thus substantially the same as a state where retardation plates are not present. Therefore, the wavelength dependency was canceled thoroughly, and coloring in a dark state was completely eliminated.

Further, in the arrangement according to this Embodiment, with respect to the viewing dependence, the slow axis of the retardation plate 21b and the slow axis of the retardation plate 22b are at substantially right angle to each other, and the slow axis of the retardation plate 21c and the slow axis of the retardation plate 22c are at substantially right angle to each other, whereby viewing characteristics are mutually canceled. Therefore, the viewing dependence is suppressed more than in the case of the liquid crystal display device of the comparison example. In addition, regarding the viewing dependence, when varying viewing directions, the orthogonal relationship between the viewing direction and the direction of the panel plane deteriorates periodically, and therefore, peaks and troughs appear periodically in the characteristic curve 31 in FIG. 3. This phenomenon is considered to appear mainly due to the polarizer.

Meanwhile, in the liquid crystal display device of the comparison example, as shown in FIG. 6, the viewing dependence is relatively large. Further, in the liquid crystal display device of the comparison example, as shown in FIG. 7, the wavelength dependence is large, and the panel looked colored in a dark state.

In this way, in the liquid crystal display device according to this Embodiment, the slow axis of the uniaxial retardation plate 21b and the slow axis of the uniaxial retardation plate 22b are at substantially right angle to each other, and the slow axis of the uniaxial retardation plate 21c and the slow axis of the uniaxial retardation plate 22c are at substantially right angle to each other, whereby the wavelength dependency is canceled, and further, the viewing dependence is suppressed.

In addition, this Embodiment describes the case where the absorption axis of the polarizer 21a and the absorption axis of the polarizer 22a are at substantially right angle to each other. However, the present invention is applicable to the case where the absorption axis of the polarizer 21a and the absorption axis of the polarizer 22a are substantially parallel to each other.

### Embodiment 2

This Embodiment describes a case that a liquid crystal display device is a transflective liquid crystal display device, and a circularly polarizer is comprised of a polarizer, a uniaxial retardation plate and a biaxial retardation plate.

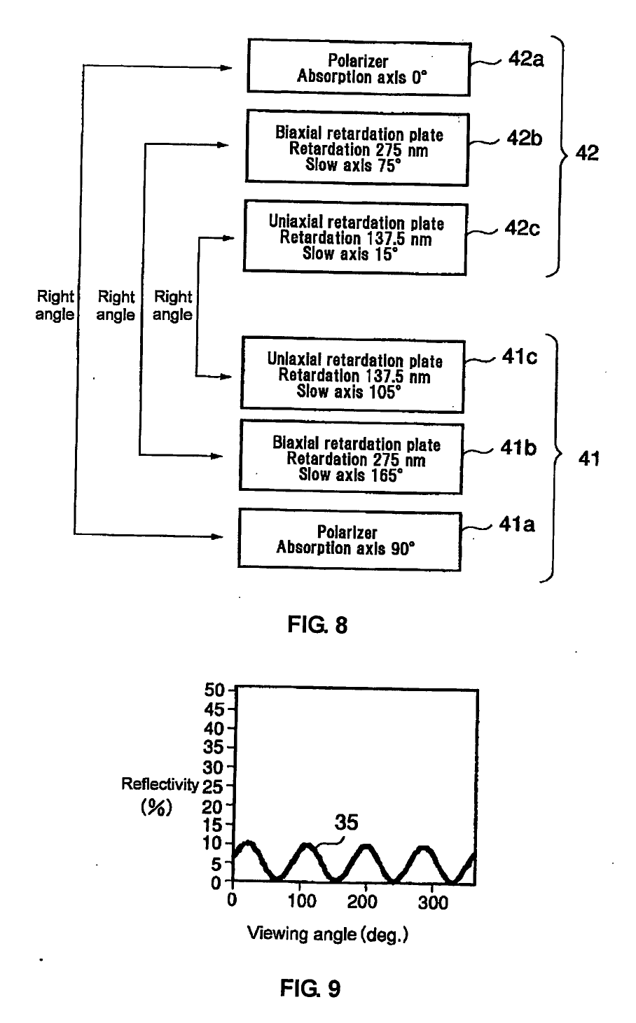

FIG. 8 is a view showing an arrangement of a circularly polarizer of the liquid crystal display device according to Embodiment 2 of the present invention. A circularly polarizers 41 is comprised of a polarizer 41a with an absorption axis of 90°, a biaxial retardation plate 41b with retardation of 275 nm and a slow axis of 165°, and a uniaxial retardation plate 41c with retardation of 137.5 nm and a slow axis of 105°. The circularly polarizer 41 is obtained by arranging the retardation plate 41c, retardation plate 41b and polarizer 41a on the glass substrate 11 in this order.

When two retardation plates are arranged between the polarizer and liquid crystal cell, it may be possible to paste one retardation plate to the polarizer and paste the other retardation plate to the liquid crystal cell, to paste two retardation plates to the polarizer successively, or to paste two retardation plates to the liquid crystal cell successively.

A circularly polarizer 42 is comprised of a polarizer 42a with an absorption axis of 0°, a biaxial retardation plate 42b with retardation of 275 nm and a slow axis of 75°, and a uniaxial retardation plate 42c with retardation of 137.5 nm and a slow axis of 15°. The circularly polarizer 42 is obtained by arranging the retardation plate 42c, retardation plate 42b and polarizer 42a on the glass substrate 12 in this order. In addition, it is necessary that the circularly polarization direction of the circularly polarizer 42 is inverse to the circularly polarization direction of the circularly polarizer 41.

The polarizer 41a of the circularly polarizer 41 and the polarizer 42a of the circularly polarizer 42 are arranged such that the absorption axis (90°) of the polarizer 41a and the absorption axis (0°) of the polarizer 42a are at substantially right angle to each other. The retardation plate 41b of the circularly polarizer 41 and the retardation plate 42b of the circularly polarizer 42 are arranged such that the slow axis (165°) of the retardation plate 41b and the slow axis (75°) of the retardation plate 42b are at substantially right angle to each other. The retardation plate 41c of the circularly polarizer 41 and the retardation plate 42c of the circularly polarizer 42 are arranged such that the slow axis (105°) of the retardation plate 41c and the slow axis (15°) of the retardation plate 42c are at substantially right angle to each other.

The operation of the liquid crystal display device with the aforementioned arrangement is the same as in Embodiment 1.

In the liquid crystal display device, since the device is provided with a pair of circularly polarizers having optical axes which are at substantially right angle to each other, in other words, since slow axes of retardation plates of the pair of circularly polarizers are at substantially right angle to each other, variations in retardation act to cancel each other. Therefore, it is possible to suppress the wavelength dependence and viewing dependence.

In the liquid crystal display device according to this Embodiment, since the circularly polarizer has a biaxial retardation plate, such a state arises that there are no variations in retardation characteristics. This respect is described in SID 92 DIGEST, pages 397 to 400, Y. Fujimura et al, “Optical Properties of Retardation Film”. Therefore, the viewing dependency is further suppressed. In addition, the Nz value (value representing a biaxial rate) of the biaxial retardation plate is preferably in the range of 0 to 1 where the viewing dependence of the retardation plate becomes small, and the most preferably, is 0.5.

Examples will be described herein which were carried out to clarify advantages of the present invention.

The wavelength dependence and viewing dependence regarding the reflectivity ware measured in the liquid crystal display device with the arrangement as shown in FIG. 8 provided with a pair of circularly polarizers having optical axes that are at substantially right angle to each other. In addition, using a spectral luminance meter, the wavelength dependence was measured in a darkroom with the spectral luminance meter arranged perpendicularly to the panel, and using a luminance meter, the viewing dependence was measured in a darkroom while rotating a bearing of the panel from 0° to 360° with the luminance meter fixed at 60° to the perpendicular direction of the panel.

In the liquid crystal display device with the arrangement as shown in FIG. 8 according to this Embodiment, the viewing dependence is as indicted by a characteristic curve 35 as shown in FIG. 9. With respect to the viewing dependence, the slow axis of the retardation plate 41b and the slow axis of the retardation plate 42b are at substantially right angle to each other, and the slow axis of the retardation plate 41c and the slow axis of the retardation plate 42c are at substantially right angle to each other, whereby viewing characteristics are mutually canceled. Therefore, the viewing dependence is suppressed. Further, since the biaxial retardation plate is used, the viewing dependence was suppressed more than in Embodiment 1.

Further, in the arrangement according to this Embodiment, with respect to the wavelength dependency, as in Embodiment 1, the wavelength dependency was canceled thoroughly, and coloring in a dark state was completely eliminated.

Thus, in the liquid crystal display device in this Embodiment, the slow axis of the biaxial retardation plate 41b and the slow axis of the biaxial retardation plate 42b are at substantially right angle to each other, and the slow axis of the uniaxial retardation plate 41c and the slow axis of the uniaxial retardation plate 42c are at substantially right angle to each other, whereby the wavelength dependence is canceled, and the viewing dependence is more suppressed.

In addition, this Embodiment describes the case where the absorption axis of the polarizer 41a and the absorption axis of the polarizer 42a are at substantially right angle to each other. However, the present invention is applicable to the case where the absorption axis of the polarizer 41a and the absorption axis of the polarizer 42a are substantially parallel to each other.

### Embodiment 3

This Embodiment describes a case that a liquid crystal display device is a transflective liquid crystal display device, and a circularly polarizer is comprised of a polarizer, and two biaxial retardation plates.

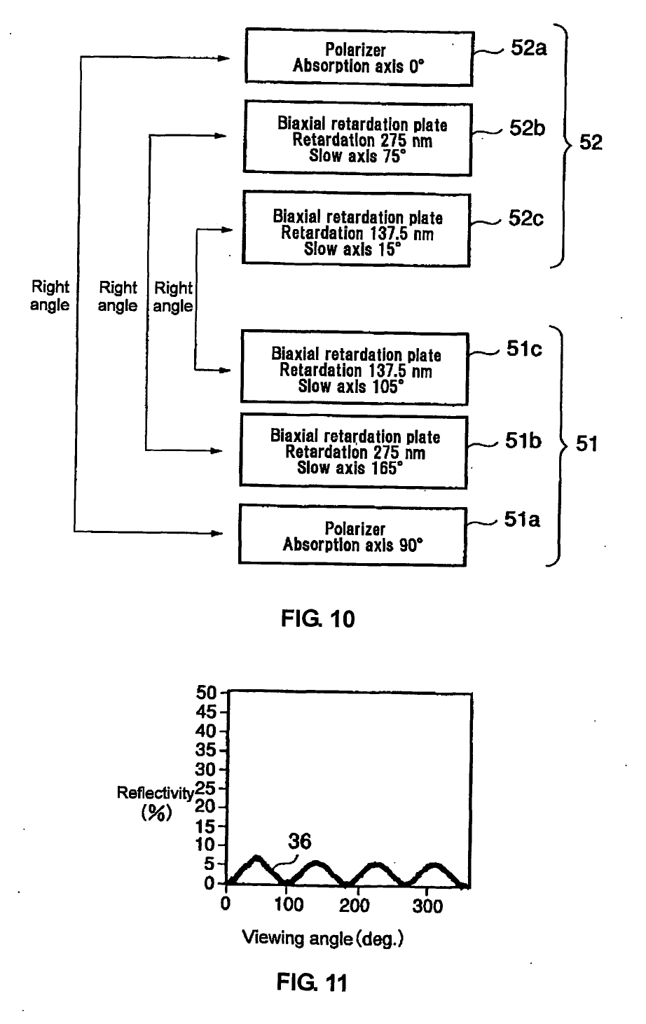

FIG. 10 is a view showing an arrangement of the circularly polarizer of the liquid crystal display device according to Embodiment 3 of the present invention. A circularly polarizers 51 is comprised of a polarizer 51a with an absorption axis of 90°, a biaxial retardation plate 51b with retardation of 275 nm and a slow axis of 165°, and a biaxial retardation plate 51c with retardation of 137.5 nm and a slow axis of 105°. The circularly polarizer 51 is obtained by arranging the retardation plate 51c, retardation plate 51b and polarizer 51a on the glass substrate 11 in this order.

When two retardation plates are arranged between the polarizer and liquid crystal cell, it may be possible to paste one retardation plate to the polarizer and paste the other retardation plate to the liquid crystal cell, to paste two retardation plates to the polarizer successively, or to paste two retardation plates to the liquid crystal cell successively.

A circularly polarizer 52 is comprised of a polarizer 52a with an absorption axis of 0°, a biaxial retardation plate 52b with retardation of 275 nm and a slow axis of 75°, and a biaxial retardation plate 52c with retardation of 137.5 nm and a slow axis of 15°. The circularly polarizer 52 is obtained by arranging the retardation plate 52c, retardation plate 52b and polarizer 52a on the glass substrate 12 in this order. In addition, it is necessary that the circularly polarization direction of the circularly polarizer 52 is inverse to the circularly polarization direction of the circularly polarizer 51.

The polarizer 51a of the circularly polarizer 51 and the polarizer 52a of the circularly polarizer 52 are arranged such that the absorption axis (90°) of the polarizer 51a and the absorption axis (0°) of the polarizer 52a are at substantially right angle to each other. The retardation plate 51b of the circularly polarizer 51 and the retardation plate 52b of the circularly polarizer 52 are arranged such that the slow axis (165°) of the retardation plate 51b and the slow-axis (75°) of the retardation plate 52b are at substantially right angle to each other. The retardation plate 51c of the circularly polarizer 51 and the retardation plate 52c of the circularly polarizer 52 are arranged such that the slow axis (105°) of the retardation plate 51c and the slow axis (15°) of the retardation plate 52c are at substantially right angle to each other.

The operation of the liquid crystal display device with the aforementioned arrangement is the same as in Embodiment 1.

In the liquid crystal display device, since the device is provided with a pair of circularly polarizers having optical axes which are at substantially right angle to each other, in other words, since slow axes of retardation plates of the pair of circularly polarizers are at substantially right angle to each other, variations in retardation act to cancel each other. Therefore, it is possible to suppress the wavelength dependence and viewing dependence.

In the liquid crystal display device according to this Embodiment, since the circularly polarizer has two biaxial retardation plates, such a state arises that there are no variations in retardation characteristics. This respect is described in SID 92 DIGEST, pages 397 to 400, Y. Fujimura et al, “Optical Properties of Retardation Film”. Therefore, the viewing dependency is further suppressed than in Embodiment 2. In addition, the Nz value (value representing a biaxial rate) of the biaxial retardation plate is preferably in the range of 0 to 1 where the viewing dependence of the retardation plate becomes small, and the most preferably, is 0.5.

Examples will be described herein which were carried out to clarify advantages of the present invention.

The wavelength dependence and viewing dependence regarding the reflectivity were measured in the liquid crystal display device with the arrangement as shown in FIG. 10 provided with a pair of circularly polarizers having optical axes that are at substantially right angle to each other. In addition, using a spectral luminance meter, the wavelength dependence was measured in a darkroom with the spectral luminance meter arranged perpendicularly to the panel, and using a luminance meter, the viewing dependence was measured in a darkroom while rotating a bearing of the panel from 0° to 360° with the luminance meter fixed at 60° to the perpendicular direction of the panel.

In the liquid crystal display device with the arrangement as shown in FIG. 10 according to this Embodiment, the viewing dependence is as indicted by a characteristic curve 36 as shown in FIG. 11. With respect to the viewing dependence, the slow axis of the retardation plate 51b and the slow axis of the retardation plate 52b are at substantially right angle to each other, and the slow axis of the retardation plate 51c and the slow axis of the retardation plate 52c are at substantially right angle to each other, whereby viewing characteristics are mutually canceled. Therefore, the viewing dependence is suppressed. Further, since two biaxial retardation plates are used, the viewing dependence was suppressed more than in Embodiment 1.

Further, in the arrangement according to this Embodiment, with respect to the wavelength dependency, as in Embodiment 1, the wavelength dependency was canceled thoroughly, and coloring in a dark state was completely eliminated.

Thus, in the liquid crystal display device in this Embodiment, the slow axis of the biaxial retardation plate 51b and the slow axis of the biaxial retardation plate 52b are at substantially right angle to each other, and the slow axis of the biaxial retardation plate 51c and the slow axis of the biaxial retardation plate 52c are at substantially right angle to each other, whereby the wavelength dependence is canceled, and the viewing dependence is more suppressed.

In addition, this Embodiment describes the case where the absorption axis of the polarizer 51a and the absorption axis of the polarizer 52a are at substantially right angle to each other. However, the present invention is applicable to the case where the absorption axis of the polarizer 51a and the absorption axis of the polarizer 52a are substantially parallel to each other.

### Embodiment 4

This Embodiment describes a case that a liquid crystal display device is a transflective liquid crystal display device, and a circularly polarizer is comprised of a wide viewing angle polarizer, and two biaxial retardation plates.

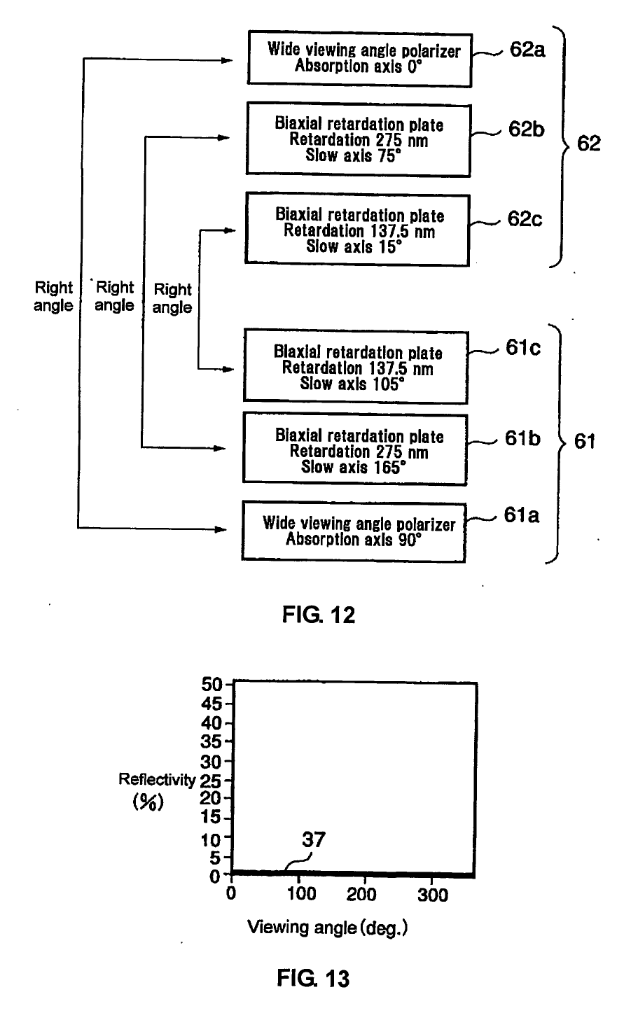

FIG. 12 is a view showing an arrangement of the circularly polarizer of the liquid crystal display device according to Embodiment 4 of the present invention. A circularly polarizers 61 is comprised of a wide viewing angle polarizer 61a with an absorption axis of 90°, a biaxial retardation plate 61b with retardation of 275 nm and a slow axis of 165°, and a biaxial retardation plate 61c with retardation of 137.5 nm and a slow axis of 105°. The circularly polarizer 61 is obtained by arranging the retardation plate 61c, retardation plate 61b and wide viewing angle polarizer 61a on the glass substrate 11 in this order.

When two retardation plates are arranged between the wide viewing angle polarizer and liquid crystal cell, it may be possible to paste one retardation plate to the wide viewing angle polarizer and paste the other retardation plate to the liquid crystal cell, to paste two retardation plates to the wide viewing angle polarizer successively, or to paste two retardation plates to the liquid crystal cell successively.

A circularly polarizer 62 is comprised of a wide viewing angle polarizer 62a with an absorption axis of 0°, a biaxial retardation plate 62b with retardation of 275 nm and a slow axis of 75°, and a biaxial retardation plate 62c with retardation of 137.5 nm and a slow axis of 15°. The circularly polarizer 62 is obtained by arranging the retardation plate 62c, retardation plate 62b and wide viewing angle polarizer 62a on the glass substrate 12 in this order. In addition, it is necessary that the circularly polarization direction of the circularly polarizer 62 is inverse to the circularly polarization direction of the circularly polarizer 61.

The wide viewing angle polarizer 61a of the circularly polarizer 61 and the wide viewing angle polarizer 62a of the circularly polarizer 62 are arranged such that the absorption axis (90°) of the wide viewing angle polarizer 61a and the absorption axis (0°) of the wide viewing angle polarizer 62a are at substantially right angle to each other. The retardation plate 61b of the circularly polarizer 61 and the retardation plate 62b of the circularly polarizer 62 are arranged such that the slow axis (165°) of the retardation plate 61b and the slow axis (75°) of the retardation plate 62b are at substantially right angle to each other. The retardation plate 61c of the circularly polarizer 61 and the retardation plate 62c of the circularly polarizer 62 are arranged such that the slow axis (105°) of the retardation plate 61c and the slow axis (15°) of the retardation plate 62c are at substantially right angle to each other.

The operation of the liquid crystal display device with the aforementioned arrangement is the same as in Embodiment 1.

In the liquid crystal display device, since the device is provided with a pair of circularly polarizers having optical axes which are at substantially right angle to each other, in other words, since slow axes of retardation plates of the pair of circularly polarizers are at substantially right angle to each other, variations in retardation act to cancel each other. Therefore, it is possible to suppress the wavelength dependence and viewing dependence.

In the liquid crystal display device according to this Embodiment, since the circularly polarizer has two biaxial retardation plates, such a state arises that there are no variations in retardation characteristics. This respect is described in SID 92 DIGEST, pages 397 to 400, Y. Fujimura et al, “Optical Properties of Retardation Film”. Therefore, the viewing dependency is further suppressed than in Embodiment 2. In addition, the Nz value (value representing a biaxial rate) of the biaxial retardation plate is preferably in the range of 0 to 1 where the viewing dependence of the retardation plate becomes small, and the most preferably, is 0.5.

Further, the liquid crystal display device according to this Embodiment uses a wide viewing angle polarizer and biaxial retardant plates, and thereby is capable of reducing the viewing dependence further. This respect is described in Asia Display/IDW'01, pages 485 to 488, T. Ishinabe et al “A Wide Viewing Angle Polarizer and a Quarter-wave plate with a Wide Wavelength Range for Extremely High Quality LCDs”.

Examples will be described herein which were carried out to clarify advantages of the present invention.

The wavelength dependence and viewing dependence regarding the reflectivity were measured in the liquid crystal display device with the arrangement as shown in FIG. 12 provided with a pair of circularly polarizers having optical axes that are at substantially right angle to each other. In addition, using a spectral luminance meter, the wavelength dependence was measured in a darkroom with the spectral luminance meter arranged perpendicularly to the panel, and using a luminance meter, the viewing dependence was measured in a darkroom while rotating a bearing of the panel from 0° to 360° with the luminance meter fixed at 60° to the perpendicular direction of the panel.

In the liquid crystal display device with the arrangement as shown in FIG. 12 according to this Embodiment, the viewing dependence is as indicted by a characteristic curve 37 as shown in FIG. 13. With respect to the viewing dependence, the slow axis of the retardation plate 61b and the slow axis of the retardation plate 62b are at substantially right angle to each other, and the slow axis of the retardation plate 61c and the slow axis of the retardation plate 62c are at substantially right angle to each other, whereby viewing characteristics are mutually canceled. Therefore, the viewing dependence is suppressed. Further, since a wide viewing angle polarizer and two biaxial retardation plates are used, the viewing dependence was suppressed completely.

Further, in the arrangement according to this Embodiment, with respect to the wavelength dependency, as in Embodiment 1, the wavelength dependency was canceled thoroughly, and coloring in a dark sate was completely eliminated.

Thus, in the liquid crystal display device in this Embodiment, the slow axis of the biaxial retardation plate 61b and the slow axis of the biaxial retardation plate 62b are at substantially right angle to each other, the slow axis of the biaxial retardation plate 61c and the slow axis of the biaxial retardation plate 62c are at substantially right angle to each other, and further, a wide viewing angle polarizer is used, whereby the wavelength dependence is canceled, and the viewing dependence is canceled also.

In addition, this Embodiment describes the case where the absorption axis of the wide viewing angle polarizer 61a and the absorption axis of the wide viewing angle polarizer 62a are at substantially right angle to each other. However, the present invention is applicable to the case where the absorption axis of the wide viewing angle polarizer 61a and the absorption axis of the wide viewing angle polarizer 62a are substantially parallel to each other.

The present invention is not limited to aforementioned Embodiments 1 to 4, and is capable of being carried into practice with various modifications thereof. For example, while Embodiments 1 to 4 describe the case where a liquid crystal display device is a transflective liquid crystal display device, the present invention is similarly applicable to a transmissive liquid crystal display device. Further, while Embodiments 1 to 4 describe the case where a passive liquid crystal display element is used as a liquid crystal cell, the present invention allows the use of active matrix liquid crystal display element.

Values in polarizers and retardation plates in Embodiments 1 to 4 are not limited to the values in the aforementioned Embodiments. In other words, these values are relative values between a pair of circularly polarizers, and therefore, are capable of being varied as appropriate, as long as the relative relationship between the pair of circularly polarizers is maintained. For example, it may be possible that a slow axis of one polarizer is a, while a slow axis of the other polarizer is α′=α±90±15. Meanwhile, it may be possible that an absorption axis of one retardation plate is β, while an absorption axis of the other retardation plate is β′=β±90±15. Further, as a retardation plate, it may be possible to use a ½-wavelength plate with a retardation value of 200 to 400 nm, or a ¼-wavelength plate with a retardation value of 50 to 250 nm.

The present invention is applicable to all the liquid crystal display devices used in cellular telephones and PDAs (Personal Digital Assistants) and to liquid crystal display devices for automobiles and aircraft.

As described above, since the liquid crystal display device of the present invention is provided with a pair of circularly polarized light means having optical axes which are at substantially right angle to each other, variations in optical characteristics such as retardation are canceled mutually. Therefore, the viewing dependence is suppressed, the wavelength dependence is canceled thoroughly, and coloring in a dark state is completely eliminated.

This application is based on the Japanese Patent Application No 2002-361294 filed on Dec. 12, 2002, entire content of which is expressly incorporated by reference herein.

1. A liquid crystal display device comprising: a liquid crystal cell having at least transmissive mode; and a pair of circularly polarized light means having optical axes which are at substantially right angle to each other, and sandwiching said liquid crystal cell.

2. The device according to claim 1, wherein said a pair of circular polarized light means comprises a pair of polarizers, and a pair of retardation plates, which are at substantially right angle to each other, arranged inside said a pair of polarizers.

3. The device according to claim 2, wherein said a pair of circular polarized light means has a plurality of pairs of polarizers.

4. The device according to claim 1, wherein said a pair of retardation plates are uniaxial retardation plate or biaxial retardation plate.

5. The device according to claim 4, wherein said biaxial retardation plate has Nz values in the range of 0 to 1.

6. The device according to claim 1, wherein at least one of said a pair of polarizers is a wide viewing angle polarizer.

7. The device according to claim 1, wherein an optical axis of said retardation plate is a slow axis.

8. The device according to claim 1, wherein said liquid crystal display device is a transflective liquid crystal display device or a transmissive liquid crystal display device.
